(19) United States
(12) Patent Application Publication
(10) Pub. No.: US 2014/0049389 A1
(43) Pub. Date: Feb. 20, 2014

(54) Devices for Facilitating Administration of a Personalized Sensory Experience and Systems and Methods Using Same

(71) Applicants: Louise Weadock, Briarcliff Manor, NY (US); Rodney Herndon, Mount Vernon, NY (US); Clyde Johnson, East Ossining, NY (US); Dan Goodman, Newburgh, NY (US)

(72) Inventors: Louise Weadock, Briarcliff Manor, NY (US); Rodney Herndon, Mount Vernon, NY (US); Clyde Johnson, East Ossining, NY (US); Dan Goodman, Newburgh, NY (US)

(73) Assignee: WEEZEE LLC, Chappaqua, NY (US)

(21) Appl. No.: 13/587,436

(22) Filed: Aug. 16, 2012

(51) Int. Cl. G08B 1/08

(52) U.S. Cl. 340/539.12; 340/539.13

(57) ABSTRACT

Devices, systems, and methods are provided that facilitate the implementation of personalized sensory plans. Through the use of various embodiments of the present invention, one or more undesirable sensory states can be mitigated.

### FIELD OF THE INVENTION

The present invention relates to the field of delivery of sensory experiences.

### BACKGROUND OF THE INVENTION

The medical and educational communities are increasingly recognizing that many people experience undesirable states of being because of sensory nervous systems that do not permit them to process their environments in the same manners as their more neuro-typical peers do. The severity of these states can vary across a spectrum from the mild, which is not always detected because many individuals learn to compensate for themselves, to the severe, which is readily apparent to both a person in the undesirable state and persons around him or her. Some of the persons who live in these undesirable states of being, or who experience them at various times of the day or week, have received clinical diagnoses, e.g., autism, sensory integration disorder or pervasive developmental delay (PDD-NOS). Others of these persons may have received no diagnoses at all.

The existence of these conditions can lead individuals to exhibit various types of behavior that are sensory craving, sensory avoiding or a combination thereof. Additionally, persons who live in or experience these states may be described as hypo-sensitive, hyper-sensitive or a combination thereof. Some of the behaviors that the above-described persons exhibit are innocuous while others can be physically harmful to the individual and/or have adverse social consequences because peers lack an understanding of why a person would engage in the behavior.

In recent years, some medical professionals and educators have recognized the benefit of providing a sensory diet to individuals who need to learn to exist more peacefully in their environments and to have an easier time processing stimuli from these environments. However, sensory diets are difficult to implement regularly and often are not implemented by persons with the appropriate training. Moreover, too frequently, they are not sufficiently personalized for the person to whom they are administered. Thus, there is a need to facilitate the efficient administration of a sensory experience to persons in need thereof.

### SUMMARY OF THE INVENTION

The present invention provides devices, systems and methods for facilitating the implementation of a sensory experience to a person in need thereof. Through the implementation of the various embodiments of the present invention, a personalized sensory experience can be delivered.

According to a first embodiment, the present invention is directed to a bracelet for facilitating administration of a personalized sensory experience, wherein the bracelet comprises an icon, wherein the icon corresponds to a sensory goal and a type of sensory input. Through use of the bracelet, a person may more easily comply with a personalized sensory plan.

According to a second embodiment, the present invention is directed to a system for facilitating administration of a personalized sensory experience comprising at least one bracelet according to one or more of the various embodiments of the present invention and at least one station, wherein the at least one station contains one more devices or structures configured to provide at least one type of sensory input that is indicated on a bracelet.

According to a third embodiment, the present invention is directed to a method for delivering a personalized sensory experience comprising: (a) obtaining a sensory profile for a person, wherein the sensory profile identifies one or more undesirable states; (b) determining a sensory plan for the person, wherein the sensory plan corresponds to strategies for addressing the one or more undesirable states identified in (a); and (c) creating a bracelet according to one or more of the embodiments of the present invention for the person, wherein on the bracelet there is at least one icon that corresponds to a sensory goal and a type of sensory input.

### BRIEF DESCRIPTION OF THE FIGURES

FIG. 1 is a representation of an embodiment of a bracelet (which may also be referred to as a wristband) of the present invention as printed on a sheet of self-adhesive label paper.

FIG. 2 is a representation of an example of a key of icons that correspond to sensory goals and types of sensory inputs according the present invention.

### DETAILED DESCRIPTION OF THE INVENTION

Reference will now be made in detail to various embodiments of the present invention, examples of which are illustrated in the accompanying figures. In the following detailed description, numerous specific details are set forth in order to provide a thorough understanding of the present invention. However, unless otherwise indicated or implicit from context, the details are intended to be examples and should not be deemed to limit the scope of the invention in any way.

According to one embodiment, the present invention is directed to a bracelet for facilitating administration of a personalized sensory experience. The term “bracelet” refers to an article that may be worn on the wrist of a person. In some embodiments, when in use the bracelet is closed, i.e., it forms a regular or irregular circle or other shape that surrounds a portion of a wrist and thus is contiguous around a complete circumference of the wrist. In other embodiments, there may be a space between two ends such that less than an entire wrist circumference is enclosed.

Throughout this disclosure, the present invention is frequently described as being of use in connection with bracelets. However, a person of ordinary skill in the art will recognize that there is no technological impediment to using the invention in connection with anklets, necklaces, belts or other accessories for association with a person. Nevertheless, implementation of the various embodiments of the present invention in connection with a bracelet provides certain advantages, including but not limited to, the ease of putting on and taking off of the device and avoidance of putting anything around the neck of a person, which can be both dangerous and disconcerting to persons who are hyper-sensitive.

By way of a non-limiting example, the bracelet may be formed from a material that comprises, consists essentially of or consists of paper, plastic or other non-stretchable material, or minimally stretchable material, that when sized appropriately on the wrist of a person cannot be slid over the hand of the person. Thus, the person wearing the bracelet may not be able to remove it without destroying the integrity of the bracelet, in which case the bracelet would not be reusable. Prior to being placed on a person, the material that will form the bracelet may be open, i.e., it is not in the form of a regular or irregular circle or other shape that forms a contiguous piece of material or set of materials.

The material or materials that are going to be used to form the bracelet may have a feature that permits closure. For example at one or both ends there may be an adhesive element. In some embodiments, the bracelet is formed from self-adhesive label paper. The self-adhesive label paper may, for example, be designed such that one or each of the ends has a peel away portion that exposes an adhesive surface that can adhere to the other end of the bracelet. The remainder of the bracelet may have a non-adhesive rear surface so that the bracelet does not adhere to a user's wrist. By forming the bracelet from a sheet, one can take advantage of a computer and printer that are configured to print icons or other information to be displayed on the bracelet. The sheet may also contain perforations that facilitate separation of the bracelet from the remainder of the sheet.

Additionally or alternatively there may be male and female mating means on opposite ends of the bracelets. In some embodiments such as those in which male and female mating means are used, the closure feature is reversible, i.e., it can be opened and then reclosed without destroying the integrity of the bracelet. In other embodiments, the closure feature is irreversible, thereby rendering the bracelet a single use item. When putting the bracelet on a person, it may be sized prior to putting the closure element into its engaged position.

The bracelet is designed to comprise at least one icon that corresponds to both a sensory goal and a type of sensory input. A “sensory goal” refers to a desired improvement in a sensory state, such as an increased tolerance to one or more stimuli, or decreased discomfort when involved in a sensory experience that would otherwise have brought on an undesired sensory state. A “type of sensory input” refers to a sensory system through which an individual experiences his or her environment, e.g., visual, auditory, taste, olfactory, or tactile. Thus, on or associated with a bracelet there may be a first icon that corresponds to a sensory goal, which may be referred to as a first sensory goal and a type of sensory input, which may be referred to as a first sensory input. Similarly, there may be a second icon, wherein the second icon corresponds to a second sensory goal and to a second type of sensory input.

As noted above, the icons that are associated with the bracelet may, for example, be printed on the bracelet. Alternatively or additionally, they may be associated with the bracelet through a linking mechanism such as a chain link. The number of icons that can fit on or be associated with a bracelet depends on the size of the icons and the size of the bracelet. By way of non-limiting examples, there may be 1 to 12 or 2 to 10 or 3 to 8 or 4 to 6 icons associated with a bracelet. These icons may, for example, be arranged in a single row or in two or more rows on the bracelet.

On a given bracelet each icon may be different from all of the other icons or one or more icons may repeat on the same bracelet. Preferably, at least two, three or four icons on a bracelet are different from one another. When there are six icons on or associated with a bracelet, the icons may be referred to as a first icon, a second icon, a third icon, a fourth icon, a fifth icon and a sixth icon. Each icon may be associated with a sensory goal and a type of sensory input, e.g., as noted above the first icon may be associated with a first sensory goal and first type of sensory input; and the second icon may be associated with a second sensory goal and a second type of sensory input; and with respect to the other icons, a third icon may be associated with a third sensory goal and a third type of sensory input; a fourth icon may be associated with a fourth sensory goal and a fourth type of sensory input; a fifth icon may be associated with a fifth sensory goal and a fifth type of sensory input; and a sixth icon may be associated with a sixth sensory goal and a sixth type of sensory input.

In some embodiments, each sensory goal, e.g., the first sensory goal and the second sensory goal, are selected from the group consisting of enhancing social relationships, improving academic performance and developing athletic coordination. In some embodiments, at least the first sensory goal and the second sensory goal are the same, and the first type of sensory input and the second type of sensory input are different. Additional or alternative sensory goals include but are not limited to: (1) improving safety by increasing balance and decreasing risk of falling; (2) increasing base of technological skills used in a classroom; (3) increasing critical thinking skills through strategic game play and motor planning; (4) increasing physical fitness overall with attention to diet and exercise; and (5) controlling mood by identifying triggers, mood swings and employing environmental/sensory elements to regulate neuro-processing.

The sensory inputs may for example be selected from the intake services in one's body: touch (either on a gross or fine level), sight, smell, taste, sound and self-in-space or a combination thereof. As persons of ordinary skill in the art will recognize, other anatomical names for the large neuro-processing areas are olfactory, gustatory, tactile, auditory, visual and proprioception, and the sensory inputs may be directed toward one or more of these neuro-processing areas.

In some embodiments, the bracelet comprises a location tracking element, which also may be referred to as a location tracking device. A location tracking element is a device that enables a system to determine where a person is within two dimensional or three-dimensional spaces. For example, the location tracking element may comprise one or more computer chips or other digital signal originators such as a near field communication element that is detectable by a reader or a sensor. The location tracking element may, for example, be affixed to the outside of the bracelet or be partially or completely enclosed within an interior compartment of the bracelet.

The digital signal originator may emit a signal that is unique to the bracelet and thus allows for detection of it and discrimination of it from other bracelets. One or more readers may be stationed at different locations or held as a smart phone device. Upon reading a signal, data is transmitted back to a central station, server, computer or storage and analytic center that is part of a network or in a cloud that indicates that the bracelet is within its vicinity. By continually monitoring for signals from bracelets, the station can automatically collect data that corresponds to when a bracelet is within a detectable range. Thus, tracking of the location of a bracelet worn by a user can be used as a proxy for a measure of how long a person is located at a sensory experience administration station. The server or other computer center that receives the data may comprise one or more central processing units, one or more memory units, input and output devices and portals to communicate wirelessly or through a wired transmission network with the stations. The server or other computer center may be configured to store information received and to track how long a bracelet is in the vicinity of a station.

Alternatively, global positioning satellite technologies can be used. However, these technologies face limitations in that they are not always able to discern movement indoors or across small spaces. Thus, when they are used, preferably the person who wears the bracelet moves across sufficiently large distances and is in an outside environment.

In some embodiments, a bracelet may comprise a bar code or QR code that is scanned upon entry into and departure from a station. When using a bar code or QR code, each station would need to be configured with a bar code reader, and each station would transmit only two pieces of time data per person per use of the station. This time data would be in addition to data that identifies the person. The bar code or QR code may be used instead of or in addition to either of the aforementioned tracking devices.

By way of a non-limiting example, the bracelets may be configured to be of use with RFID technologies, such as those of Precision Dynamics Corporation, the scanner may be one such as those available from NFC Gears, the database may be one such as available from iScanlist, and the grid application may be one such as a SerialIO product that is available from Mobile Grid. When smart phones are used for tracking, one may for example use a Google/Samsung product that runs the Android iOS (Google).

The above embodiments describe the location tracking device as being part of the bracelet. However, as persons of ordinary skill in the art will readily appreciate, these location tracking devices may be part of separate bracelets (e.g., a participant wears a pair of bracelets) that are worn on the same or other arm on which the bracelet with the icon is worn. Additionally, when not part of the bracelet that contains the icons, the location tracking device may be in the form of an article other than a bracelet, for example, an anklet, a necklace or an accessory to attach to a belt or to a belt loop. Because of the cost of certain tracking elements, it may preferable if they are reusable even if a bracelet that contains the icons described above is for single use only.

As described in more detail below, the sensory experiences to which persons are exposed may be either user-driven or monitored or initiated by another person. However, in many embodiments, there is no need for a one on one caregiver or professional to shepherd the user from station to station. Instead, a person may be able to move on his or her own from station to station.

According to another embodiment, the present invention provides a system for facilitating administration of a personalized sensory experience. The system comprises at least one bracelet according to one or more of the various embodiments of the present invention. The system also comprises at least one station that contains one more devices or structures configured to provide the least one type of sensory input of at least one icon on the bracelet. The at least one station may, for example, comprise 2 to 50 or 3 to 30 or 4 to 20 different stations. The stations may be located near each other, e.g., within the same room or on the same floor or within the same building. Each station may provide the tools for the participant to accomplish one or more sensory goals and to facilitate one or more types of sensory input. Although part of the same system, each station may be a stand-alone structure or area.

The at least one station may comprise one or more markings that are the same as one or more icons on the bracelet. Examples of stations that are part of the same system include but are not limited to at least one, at least two, at least three, at least four or at least five of a climbing wall, a sports simulator, a vibration station, a rain room, a wind walk, a rope bridge, a pottery room and an oxygen bar.

According to another embodiment, the present invention provides a method for delivering a personalized sensory experience. The method may begin with obtaining a sensory profile for a person, wherein the sensory profile identifies up to eight undesirable states, e.g., two to eight, or four to eight or four to six. Examples of undesirable states include but are not limited to hand flapping, chewing one's hands or clothing, excessive jumping, social or physical withdrawal, screeching, screaming into one's shirt, low attention span, being echolalic, being non-verbal, being hypotonic, being hypertonic, having abusive behavior and having aggressive behavior. There is no technological limit to identifying more than a predetermined number of undesirable states. However, there can be advantages to limiting the number that are being addressed at any one time.

A “sensory profile” is a description of form savant to undesirable behaviors or sensory states. It may be obtained, for example, by receiving answers to questions on a questionnaire, from parents, caregivers or teachers or a combination thereof. The questions may ask about certain behaviors of a person under certain conditions, e.g., responses to crowds, loud noises or bright lights. This process may be automated and created through the use of a computer program product. Alternatively, a first person may question a second person, or the caregiver of the second person, wherein the second person is the one who experiences the undesirable states.

Next according to the method, one determines a sensory plan for the person. The sensory plan corresponds to strategies for addressing undesirable states that were identified, and is created based on the goal of desensitizing or sensitizing a person to sensory stimuli, the exposure to which will help to alleviate or to ameliorate one or more undesirable conditions. The plan may, for example, be created by consideration of the sensory profile and prioritizing sensory goals at home, at school and at other community activities. The sensory plan may be created by a professional who has knowledge of how to interpret answers to the questionnaire or by a computer program that contains an algorithm that interprets and analyzes the answers and then forms a plan.

Then one creates a bracelet according to one of the embodiments of the present invention for the person, wherein associated with the bracelet are icons that correspond to the sensory plan. The bracelet may be created by printing on a self-adhesive sheet as described above and forming a bracelet from the appropriate part of the sheet.

A person who wears the bracelet goes to at least one station and takes part in the experience that the station is configured to provide. The plan may be designed such that the person stays at a station for a predetermined or at least a minimal amount of time. For example, a plan may require that a person stay at each station that he or she visits for two to twenty minutes or three to fifteen minutes or five to ten minutes. Upon completion of a station, for the desired time period, the person, or someone else may make a denotation on the icon that indicates that the person has spent the requisite time at the station. For example, a line or an “X” may be placed through the icon. Because on a bracelet, the same icon may appear two or more times, the person's plan may allow for the person to spend more than one unit of time at a station. In order to assist in keeping track of time, the station or the person entering it may have a stop watch or countdown clock; for example, the bracelet or location tracking device could comprise a countdown clock. The countdown clock, if present, may comprise an audible and/or vibrating alarm feature that is activated upon expiration of time on the clock.

If the person's bracelet is equipped with or is associated with a tracking element, the station may check the person in when he or she is within proximity of reader that enables the reader to detect the element. The system may continually monitor the tracking element and thus the user as well, and then send data to a central processing station that compares at least the first and the last time at which there is detection. This will enable the determination of the length of time that a person spends at a station. This tracking may be done at a plurality of stations, e.g., at least two, at least three, at least four, etc.

At regular or irregular intervals, or by request, the system may analyze the data received from each station. It may then compare this data to the sensory plan in order to determine to what degree a person complied with his or her plan. This monitoring may be done in real-time so that notification can be sent to the person or a staff member when the person has stayed too long at a station. Alternatively or additionally, this monitoring may be done at regular or irregular intervals and analyzed to determine where, when, and to what extent a person deviates from his or her sensory plan. This information may be analyzed and future plans for the person may be designed to take into account sensory seeking or avoiding behavior as revealed by a tendency to gravitate toward or away from certain stations. Additionally, because more than one station may provide the same type of sensory input at and/or the same type of sensory goal, the processor may analyze to which stations a person gravitates, even when complying with his or her sensory plan. With this data, it can provide a second sensory plan that takes into account not only what a caregiver or the person himself or herself initially disclosed but what the person actually chose. For many persons who visit the systems of the present invention, it will be advantageous to come multiple times over different days, weeks, or months. For each one or every few visits, a new sensory plan may be created. In embodiments in which a bracelet is a single-use item, even if a new sensory plan is not created, a new bracelet may be used.

In various embodiments described above, the station is described as containing a signal detection feature and being capable of transmitting information to the central station for analysis. However, the system can be configured in reverse. Thus, the station can emit the signal to be detected, and the wearer of the bracelet can be associated with a device that searches for the signal and transmits information back to the central station for processing and analysis.

Various embodiments of the present invention may be further understood by reference to the accompanying figures.

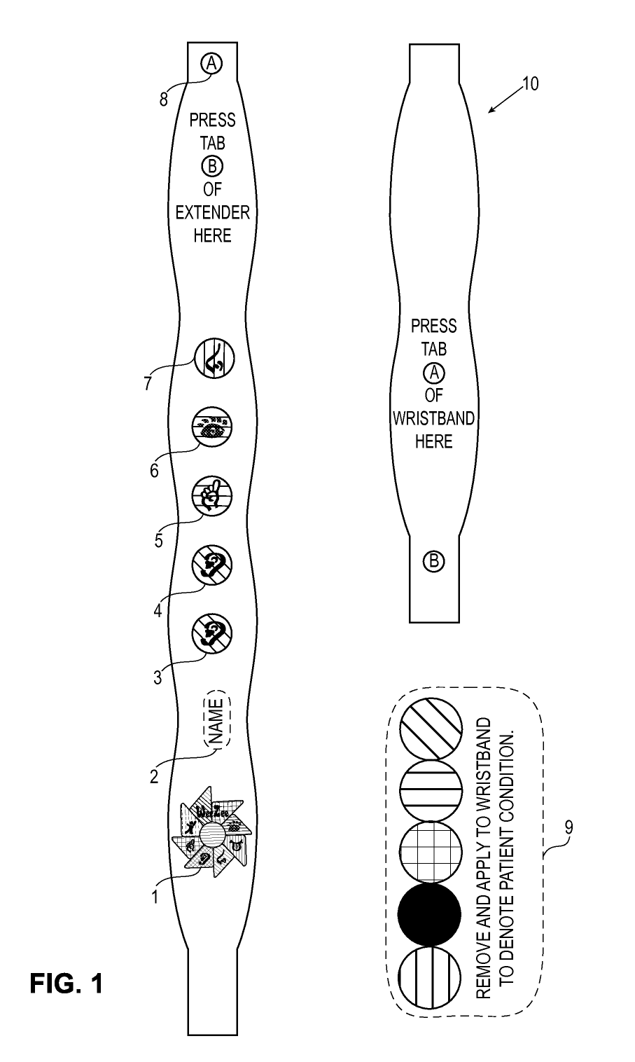

FIG. 1 is a representation of a bracelet of the present invention. The bracelet may be printed onto a sheet that is designed to allow for separation from the sheet and configuration into a bracelet. The bracelet may for example contain a symbol denoting the source of the bracelet 1. It may also have a place for a person's name 2, and icons, 3, 4, 5, 6, 7, which represent sensory goals and inputs. Depending on printing capabilities, different icons may each have distinct colors. As shown icons 3 and 4 are the same. There may also be a location to line up an extender 8. FIG. 1 also shows the extender 10, which can be used when the person with whom the bracelet will be associated has a wrist that is larger than the standard bracelet of the sheet.

Further, there may also be circles or other shapes or symbols that represent different disorders or medical conditions 9. If they have no words or abbreviations that describe a disorder or medical condition, they may be referred to as coded. These can be affixed to the bracelet in order to alert persons as to a medical condition of a user and because a plurality of these coded or encrypted elements may be printed on the sheet with the bracelet, one or more can be affixed to the bracelet as needed. For example, they may indicate that a wearer has autism or a hearing impairment. These indicators of a condition may be designed such that they do not explicitly state the disorder or medical condition. By not explicitly stating the disorder or medical condition, the bearer's privacy can be maintained.

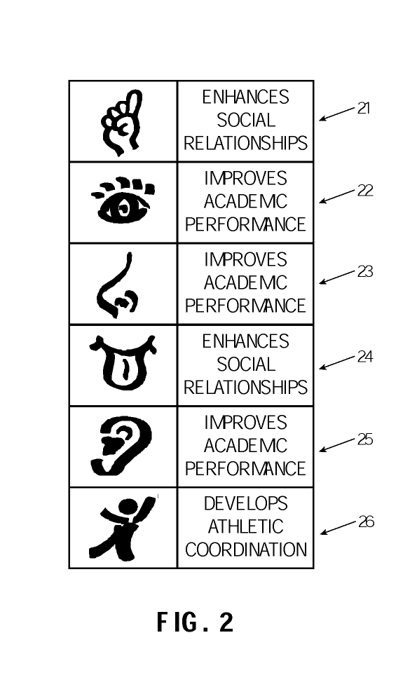

FIG. 2 is an example of a key for icons that may be used on a bracelet. The icons shown are: (1) enhances social relationships through tactile stimuli 21; (2) improves academic performance through visual stimuli 22; (3) improves academic performance through olfactory stimuli 23; (4) enhances social relationships though taste stimuli 24; (5) improves academic performance through auditory stimuli 25; and (6) develops athletic coordination through vestibular or proprioceptor stimuli. 26. One will note that goals on the right side of the key repeat. However, the forms of sensory input on the left side of the key do not. Because not all users will know how to read, the use of icons may be advantageous. Additionally, each station may have one or more icons associated with it.

By way of further example, a building may contain one or more if not all of the stations described below, which provide one or more types of sensory input in order to accomplish one or more types of sensory goals. Additionally, in any one or more stations, a user may be provided with auditory stimuli. Auditory stimuli may be provided through for example speakers that may be heard by anyone within the proximity of the speakers and/or by being transmitted wirelessly or through wired technology to headphones that a person wears. Additionally, rather than wearing headphones for amplification, a person may wear them to filter out noises. Furthermore, each station may be visited alone or in the presence of other persons whose plans call for exposure to stimuli that the station is designed to administer. Below is a more detailed description of two dozen stations, any one or more of which, e.g., at least five, at least ten, at least fifteen may be present. For convenience, one or more of numbers 21-26 are provided in the description of each station. These numbers correspond to the numbers that are associated with the icons in FIG. 2.

(A) Reception: 22, 25, 21, 26, which refers to an entryway that is designed with e.g., stationary or mobile objects to view, music of decibel levels and melodies to soothe, and objects of varying textures along walls or counters to touch, to push, to pull or on which to lean.

(B) Café: 24, 23, 25, which refers to an area where food may be ordered and/or served. Various embodiments of this station focus on providing foods that supply a desired sensory experience in an environment that is conducive to a person's trying new sensory experiences in one's mouth as well as eating nutritional foods.

(C) Oxygen bar: 22, 23, which refers to a location where a person has access to gases with the same or increased concentration of oxygen relative to air. This station focuses on using aroma therapy as a means for relaxation and/or energy. The goals of this station include providing an opportunity for social growth while simulating an olfactory sense and releasing tension and/or stress. The oxygen bar may be equipped with one or more if not all of oxygen tanks, beakers, tubes, scented oils, nose buds, and stools.

(D) Groove grove: 22, 25, 21, which refers to a station that has real or digital instruments for making music. This station focuses on identifying a person's musical strength and abilities, while also identifying areas in which he or she would like to improve. The goals of this station include one or more if not all of: (1) to use music as a means for self-expression, to increase self-esteem, to improve mood, and to encourage creativity; (2) to allow a person to practice musical skills independently, or to provide opportunities for cooperative play, creating music and/or singing; (3) to improve social skills, physical skills, and team building skills; and (4) to allow for release of stress and tension, to work on improving impulse control, and to increase concentration and focus.

In some embodiments the groove grove comprises one or more if not all of an electric guitar, electric bass, bass amp, a guitar amp, electric drums, an electric keyboard, a microphone and a computer or computer program product to simulate music experiences, such as Karafunplayer, a Nintendo Wii, Rock Band, Dance Revolution and XBox or Xbox Kinex.

(E) Half pipe: 26, which refers to a structure that is modeled after structures that are used in gravity extreme sports such as snowboarding and skateboarding. The structure may resemble a cross-section of a swimming pool; thus, the inner surface is shaped like two concave ramps or quarter pipes and optionally may be topped by decks that face each other across a flat transition. This station focuses on one or more of the following: (1) stimulating a participant's mind and body; (2) providing a proprioceptively enriched environment in changing planes of motion; (3) establishing a person's ability to handle an appropriate level of difficulty; and (4) challenging one's body by using balance and core strength to remain on a board. As persons of ordinary skill in the art are aware, proprioception refers to the sense of the relative position of neighboring parts of the body and the strength of effort being employed in movement.

Among the goals of this station are one or more if not all of: (1) to provide physical and visual stimulation; (2) to challenge one to balance and to be stable; (3) to improve the physical capabilities of the participant; (4) to promote physical health and development; and (5) to promote an environment that allows for progress through individual effort.

(F) Pro zone: 22, 25, 21, 26, which refers to a station that comprises one or more if not all of the following: Makoto, a sports wall, playground balls, medicine balls, sandbags and foam tubes. (Makoto refers to a game that measures one's reaction time and accuracy by visual and auditory processing.)

This station focuses on: (1) stimulating a participant's body and mind at an advanced level; (2) providing a challenging array of functional training activities; (3) establishing a person's ability to perform motions or exercises safely and responsibly; (4) selecting and setting up appropriate combinations of modalities; (5) rotating the activities/games/levels at a rate that keeps participants engaged; and (6) challenging one's body and central nervous system by testing coordination, reaction time, reflexes, physical ability and speed.

The goals of this station include one or more if not all of the following: (1) to provide physical and visual stimulation; (2) to challenge speed, agility and reflexes; (3) to improve the physical capabilities of the participant; (4) to promote physical health and development; and (5) to promote an environment that allows for progress through individual effort.

(G) Physical training area, also referred to as functional training area: 22, 25, 21, 26, may comprise one or more, if not all of the following: heavy bags, sand bells, sand balls, hurdles, cones, mats, agility ladders, battle ropes, agility dots, and mixed martial arts gloves. This station focuses on: (1) stimulating a participant's body and mind at an advanced level; (2) providing a challenging array of functional training activities; (3) establishing a person's ability to perform motions or exercises safely and responsibly, identifying areas that would benefit from improvement and to designing/assigning drills or routines appropriately for small groups of participants; (4) selecting and setting up appropriate combinations of modalities; (5) rotating the activities/games/levels at a rate that keeps participants engaged; and (6) challenging one's body and central nervous system by developing coordination, agility, reflexes, physical ability and speed.

The goals of this station include one or more if not all of the following: (1) to provide physical and visual stimulation; (2) to challenge speed, agility, strength and reflexes; (3) to improve the physical capabilities of the participant; (4) to be able to assign specific beneficial movements to participants; (5) to exist as a resource for knowledge on the development of physical ability; (6) to promote physical health and development; and (7) to promote an environment that allows for progress through individual effort.

(H) Reaction wall: 22, 21, 26, which refers to a wall that is configured to present stimuli at different locations along its surface. A person's task is to respond to the stimuli by for example touching them when presented. This activity focuses on: (1) stimulating a participant's body and mind; (2) establishing a participant's ability to perform certain levels of difficulty; (3) selecting and setting up appropriate games using e.g., BATAK™, which is a piece of equipment that is designed to improve reaction speed, hand-eye coordination and stamina by presenting a plurality of sensors, each of which can present a visual stimulus and can register a response such as a person touching a sensor in the proximity of the visual stimulus; (4) rotating the activities/games/levels at a rate that keeps participants engaged; (5) challenging one's body and central nervous system by testing coordination, reaction time, reflexes and speed; and (6) promoting a positive and beneficial experience. The goals of the reaction wall include one or more if not all of: (1) to provide physical and visual stimulation; (2) to challenge reaction time, agility and reflexes; (3) to determine and to select an appropriate level of difficulty on the system; (4) to improve the physical capabilities of the participant; (5) to promote physical health and development; and (6) to promote an environment that allows for progress through individual effort.

(I) Sports simulator: 22, 25, 26, which may comprise one or more if not all of a sport simulator, a baseball, a softball, a bat, a hockey stick and a puck or ball, a basketball, a football, a soccer ball and foam tubes. This activity focuses on; (1) stimulating a participant's mind and body; (2) simulating real world sports; (3) establishing a person's preference of game type (e.g., baseball, basketball, football); (4) challenging one's body; (5) promoting the development of sports abilities by simulating their basic mechanics; and (6) promoting self-esteem by tracking improvements and records within the activity.

The goals of this station include one or more if not all of the following: (1) to provide visual and physical stimulation; (2) to encourage exploration of various types of sports; (3) to provide guidance through each sport's appropriate movement; (4) to improve the physical capabilities of the participant; (5) to promote mental and physical health; and (6) to promote an environment that allows for challenge and progress through individual effort.

(J) Climbing wall: 22, 21, 26, which refers to a wall that may have a plurality of rocks protruding from it that that a user may step on and/or grab onto in order to climb the wall, as well as one or more locations with either fabric hook or loop fastening materials, i.e., one half of a Velcro based engagement system. There may also be plurality of separate units each of which comprises one or more letters, numbers, word, symbols or graphics that on one side have the reciprocal portion of the Velcro based engagement system. As a person of ordinary skill in the art will readily recognize, a user can be tasked with either putting the units on the wall or taking them off of the wall. In order to facilitate transporting the units, the user may wear a belt or sash that comprises the same portion of the fastening system that is on the wall.

This activity focuses on providing a fun and engaging physical experience where the person can engage in various activities that permit him or her to become associated and disassociated from the wall and if he or she so desires to climb the wall. The goals of using this station include one or more if not all of: (1) to maintain and to improve physical skills and muscular strength; (2) to maintain and to improve hand-eye coordination; (3) to promote a fun and positive experience; and (4) to allow the user to be able to learn and to succeed at games or activities using the Velcro wall.

(K) Slide park: 22, 25, 21, 26, which refers to playground equipment with one or more slides, e.g., two to five slides that may be open or enclosed and one or more ladders by which to reach the top of the slides. Accordingly, this station may comprise one or more of mats, climbing equipment and one or more slides. Furthermore, associated with or as part of the slide park may be a rope bridge, which may comprise, consist essentially of or consist of two or three horizontal ropes that a person may use to transverse a distance above the ground. Various embodiments of this station utilize a slide park in order to create a physical and social environment.

Among the goals of the slide park station are one or more if not all of the following: (1) to engage vestibular, and proprioceptive senses through various equipment provided; (2) to allow opportunities for strategizing by means of physical exploration; and (3) to maintain and to improve gross motor skills, social skills, cognitive skills, and to encourage independent play.

(L) Rain forest: 22, 21, 26, which refers to a simulated rain forest with respect to one or more stimuli of sight, sound, wind and/or water in, for example, the form of mist. This station may be located in the proximity of a rain room, 22, 25, 21, 26, which refers to a room in which water is emitted from one or more walls or the ceiling, and a wind walk, 21, 26, which refers to a stretch of one or more sources of air currents that are emitted from one or more panels or devices associated with a wall, a floor, a ceiling or a combination thereof, and lockers for changing before and/or after experiencing the rain forest. These three stations may each exist as stand-alone stations or as a combined station. In the latter case, a person may enter the rainforest, proceed directly to the rain room, and then proceed directly to the wind walk station.

Various embodiments of these stations focus on one or both of: (1) promoting a positive experience through visual, auditory and tactile stimulation using water and different sounds a rain forest; (2) offering a fun, engaging and energizing experience and chance to get wet; and (3) experiencing different forces on one's skin. Among the goals of these stations are: (1) to provide an experience where people can get wet and to experience other sensations on one's skin; (2) to reduce fears of water and the feeling of water on one's body; (3) to increase independence and self-esteem; and (4) to promote cooperative skills by taking turns while in a group.

(M) Tour de Weez: 22, 26, which refers to a simulated vehicular racing activity, e.g., racing bikes or motorcycles, on a computer screen where the user controls the speed and activity of his or her car. The user may sit on a racing bike or motorcycle that can tilt to the right, to the left, and in some embodiments forward and/or backward thereby providing the user with the sensory feeling of a change in three-dimensional space. This activity focuses on: (1) stimulating a participant's mind and body; (2) adding an additional dimension to cardiovascular exercise; (3) establishing a person's preference of game type (e.g., race, explore, relaxing cruise); (4) challenging one's body while having fun by racing friends, oneself, or exploring a landscape via an integrated screen; and (5) promoting self-esteem by tracking improvements, while record the activity.

The goals of this activity are: (1) to provide visual and physical stimulation; (2) to encourage exploration within the game and of one's own physical abilities; (3) to improve the physical capabilities of the participant; (4) to promote mental and physical health; and (5) to promote an environment that allows for challenge and progress through individual effort.

(N) Vibration Station: 22, 21, which refers to a location that vibrates, thereby causing a person who is seated or standing on it to move back and forth and/or side to side. This station may for example comprise a structure on or in which a person can sit or stand such as a replica of a train or a snake. The structure may be configured to move or to vibrate under the control of a person who sits in or on it, or under the control of another person or pre-programmed device or computer. The station may also comprise one or more vibration pillows and/or foot panels. Optionally, it may be configured to provide auditory stimulation. The pillows may be designed to be soft and with different textures and associated with the station such that when the station vibrates they vibrate as well. Because they have different textures, persons can select which type of sensory input they are seeking and put it against any part of their bodies, e.g., face or legs. The foot panels may also vibrate with the structure and provide one or more different surfaces on which a person may place his or her feet.

The panels may be configured to slide so that when the structure moves or vibrates, the foot panels move after a short lag time.

The vibration station focuses on establishing a person's ability to tolerate vibrations through tactile, auditory and vestibular stimulation. Among its goals is one or are both of the following: (1) to promote tactile stimulation; and (2) to promote auditory and vestibular stimulation.

(O) Cyberaction floor: 22, 25, 26, which refers to an activity wherein visual stimuli are present on a floor and users are tasked with responding to the stimuli by for example touching a sensor near a stimulus. Optionally, there may be sound in addition to the visual stimuli. To implement the cyberaction floor, in addition to the floor itself, there may be a computer, a keyboard, a remote and a projector. Thus, the focus of this activity is to provide a fun and engaging experience where a person can use his or her body to engage in game play.

Goals of the cyberaction floor include but are not limited: (1) to maintain and to improve physical skills, and to stimulate auditory and visual senses; (2) to allow for cooperative play and opportunities to improve frustration tolerance, impulse control, taking turns, socialization, and problem solving; (3) to increase the length of time focused on task and improve self-esteem and self-worth; and (4) to improve reaction time, endurance, range of motion, and gross motor coordination.

(P) Pottery Room: 22, 21, 26, which refers to a place where a person may create objects from clay. This station may be equipped with clay, a potter's wheel, and a kiln. Goals of this station include training a person to respond appropriately to touch and to increase social interaction.

(Q) Hammocks: 21, 26, which refers to a location where a person may sit, swing, or lie in a hammock. A hammock may serve a dual purpose of providing a place to relax, and through its swinging motion, provide stimulation to one's inner ear.

(R) Rockin' Rodeo: 26, which refers to a simulated bull ride. This activity focuses on increasing the ability of a participant to act independently and promoting a positive experience through balance and individual strength and coordination. The goals of the rockin' rodeo may include one or more if not all of: (1) to provide a sense of success by being able to balance and coordinate one's body with the ability to remain on the device for a longer period of time with each use; (2) to improve balance and coordination; (3) to increase self-esteem and reduce sense of fear; and (4) to improve focus and concentration.

(S) Galaxzee: 22, 25, 21, which comprises one or more if not all of a device that plays music, e.g., CD's and a speaker system or boom box, light effects, two ball pits—both of which are lighted and one of which is a vibration pit, a bubble tower with fiber optic cables, aroma therapy machine, plush/inflated accessories, and tactile wall puzzles. When in use, a person may explore each of the aforementioned elements and engage in play, thereby directing the sensory stimulation that he or she receives. The station focuses on: (1) engaging a person in a calming and soothing sensory experience; and (2) identifying what senses are pleasing and displeasing to each child. The goals of the this station includes one or more of: (1) to provide a plurality of sensory experiences (visual, auditory, olfactory and tactile); (2) to improve frustration tolerance by allowing for a self-soothing experience and for total body relaxation; and (3) to improve focus, concentration and impulse control.

(T) Brain Games: 22, 25, 21, which refers to a location where games may be played. The games may be selected to enhance academic performance and social skills through the use of cooperation and/or competition. Through playing these games, one may accomplish one or more of the following goals: (1) to promote teamwork, strategic thinking and cooperative play; (2) to improve frustration tolerance and impulse control; (3) to maintain and to improve fine and gross motor skills; (4) to encourage creativity and independent thinking; (5) to release tension and stress while promoting a fun and positive environment; and (6) to maintain and to improve verbal skill, while increasing length of stay in an activity. Examples of brain games activities include but are not limited to table games such as board games, smart boards, luminosity computers, and brain bikes.

(U) Lil-Pro zone: 22, 25, 21, 26, which refers to a location where a young child may engage in real or simulated sports activities. This station may comprise a sports wall that simulates stimuli found in a sport setting and to which a child may respond. It is similar to the aforementioned pro-zone, but it is configured on a smaller scale and for young children. Among its focus is to stimulate auditory, visual and proprioceptive senses in a controlled environment.

The goals of the lil-pro zone include one or more if not all of the following: (1) to engage vestibular and proprioceptive senses through sound and interactive games; (2) to encourage cooperative or independent play; (3) to challenge speed, agility and reflexes in a fun environment; and (4) to maintain and to improve gross motor skill, social skills and cognitive skills.

(V) Creation station: 22, 21, which refers to a place where a person may create arts and crafts. Various embodiments of this station comprise one or more if not all of the following: paper and easels that optionally are attached to a wall; a wall on which to paint; paints; paint brushes, markers, crayons, water and paper towels with which to clean the brushes.

The creation station activities focus on identifying a person's likes and dislikes and identifying one or more art activities in which they are interested in engaging. Among the goals of this station are one or more if not all of the following: (1) to allow for self-expression through various art mediums; (2) to improve self-esteem and self-worth, and allow for self-expression; (3) to engage independently or cooperatively with peers; (4) to tolerate sharing art supplies and space; (5) to remain engaged and focused on task; (6) to reduce stress, tension, and anxiety; (7) to improve frustration tolerance and impulse control; and (8) to encourage a person to be responsible and independent, i.e., cleaning up after himself of herself.

(W) “Wee Wonz” also referred to as “Tot Zone”: 22, 25, 21, 26, which refers to a station for small children that includes a set of devices that permit a user to obtain an intended sensory experience and is particularly useful for children who are approximately three years of age or younger. These devices may include one or more if not all of Jump-o-leen (which refers to a small jumping area that comprises an air filled floor off of which to jump and preferably side walls in order to prevent a person from falling out of the device), a bubble tower, swings, a somatron corner (which refers to a crawl space), bean bag chairs, a balance beam, an imagination playground, johnny jump-ups (suspended seats that permit a child to push off of the floor with his or her legs and leave the ground), mirrors, blocks, Legos®, mirrors, and tactile toys.

The Wee Wonz station focuses on providing a sensory stimulating environment. The goals of the group include but at not limited to: (1) maintaining and improving auditory, visual, tactile, vestibular, and proprioceptive senses through various equipment provided in the designated area; (2) allowing infants and toddlers an opportunity to engage in cooperative or solitary play; and (3) encouraging caregivers to be active and involved with their children, while learning new techniques in which to engage their children in play.

(X) Zen Den: 22, 25, 26, which refers to a location that is designed to allow a person to relax. This station may comprise or consist essentially of, or contain, cushioned chairs, calming aromas, music and walls and carpets that contain soothing colors.

Examples of bracelets may comprise, consist essentially or consist of the following combinations of icons:

21, 22, 23, 24, 25, 26;
21, 22, 23, 24, 25;
21, 22, 23, 24, 26;
21, 22, 23, 25, 26;
21, 22, 24, 25, 26;
21, 23, 24, 25, 26;
22, 23, 24, 25, 26;
21, 22, 23, 24;
21, 22, 23, 25;
21, 22, 23, 26;
21, 22, 24, 25;
21, 22, 24, 26;
21, 22, 25, 26;
21, 23, 24, 25;
21, 23, 25, 26;
21, 23, 24, 26;
21, 24, 25, 26
22, 23, 24, 25;
22, 23, 24, 26;
22, 23, 25, 26;
22, 24, 25, 26;
23, 24, 25, 26.

Additionally, any one of the icons represented by 21, 22, 23, 24, 25, or 26 may be repeated one or more times with any of the aforementioned combinations. If an icon repeats, the plurality of the same icons may or may not be grouped. If a wearer of a bracelet is instructed to follow the order of the icons, it may be preferable not to have the same icons next to each other.

Additionally, when following the plan on a bracelet, a person may visit any combination of stations that correspond to the icons on the bracelet. Optionally, a wearer may, even the icons on the bracelet repeat, be instructed not to visit the same station twice. Alternatively, the wearer may have the freedom to visit the same station twice provided that he or she is complying with his or her sensory plan. For example, following the icons on a bracelet, a wearer of the bracelet may visit one or more of the following sets of three environments and gain exposure to the sensory stimuli provided therein:
Sports Simulator, Pro Zone, Brain Games
Sports Simulator, Physical Training Area, Climbing Wall
Half Pipe, Tot Zone, Brain Games
Sport Simulator, Vibration Station, Brain Games
Physical Training Area, Climbing Wall, Pro Zone
Vibration Station, Tot Zone, Rockin' Rodeo
Tour de Weez, Slide Park, GalaxZee
Lil' Pro Zone, Vibration Station, Groove Grove
Climbing Wall, Tour de Weez, Physical Training Area
Wind Walk, Rain Room, Brain Games
Slide Park, Vibration Station, Climbing Wall
Pro Zone, Tour de Weez, Groove Grove

Any of the features of the various embodiments described herein can be used in conjunction with features described in connection with any other embodiments disclosed unless otherwise specified. Thus, features described in connection with the various or specific embodiments are not to be construed as not suitable in connection with other embodiments disclosed herein unless such exclusivity is explicitly stated or implicit from context.

We claim:

1. A bracelet for facilitating administration of a personalized sensory experience, wherein the bracelet comprises an icon, wherein the icon corresponds to a sensory goal and a type of sensory input.

2. The bracelet of claim 1, wherein the icon is a first icon, the sensory goal is a first sensory goal and the type of sensory input is a first type of sensory input, and the bracelet further comprises a second icon, wherein the second icon corresponds to a second sensory goal and a second type of sensory input.

3. The bracelet of claim 2, wherein the first sensory goal and the second sensory goal are each selected from the group consisting of enhancing social relationships, improving academic performance and developing athletic coordination.

4. The bracelet of claim 2, wherein the first sensory input and the second sensory input are each selected from the group consisting of touch, sight, smell, taste, sound and a combination thereof.

5. The bracelet of claim 4, wherein the first sensory goal and the second sensory goal are the same, and wherein the first type of sensory input and the second type of sensory input are different.

6. The bracelet of claim 4 further comprising a third icon that corresponds to a third sensory goal and a third type of sensory input.

7. The bracelet of claim 1, wherein an icon appears at least two times on the bracelet.

8. The bracelet of claim 1, wherein the bracelet further comprises a location tracking device.

9. The bracelet of claim 1 further comprising a coded denotation of a medical condition or disorder.

10. A pair of bracelets, wherein the pair comprises a first bracelet, wherein the first bracelet is the bracelet of claim 1 and a second bracelet, wherein the second bracelet comprises a location tracking device.

11. A system for facilitating administration of a personalized sensory experience comprising at least one bracelet according to claim 1 and at least one station, wherein the at least one station contains one more devices or structures configured to provide the least one type of sensory input of the icon.

12. The system according to claim 11, wherein the at least one station comprises a marking that is the same as the icon.

13. The system according to claim 11, wherein the at least one station comprises at least one of a climbing wall, a sports simulator, a vibration station, a rain room, a wind walk, a rope bridge, a pottery room and an oxygen bar.

14. The system according to claim 13, wherein the at least one station comprises at least two of a climbing wall, a sports simulator, a vibration station, a rain room, a wind walk, a rope bridge, a pottery room and an oxygen bar.

15. The system according to claim 14, wherein the at least one station comprises at least three of a climbing wall, a sports simulator, a vibration station, a rain room, a wind walk, a rope bridge, a pottery room and an oxygen bar.

16. A method for delivering a personalized sensory experience comprising:
(a) obtaining a sensory profile for a person, wherein the sensory profile identifies one or more undesirable states;
(b) determining a sensory plan for the person, wherein the sensory plan corresponds to strategies for addressing the one or more undesirable states identified in (a); and
(c) creating a bracelet according to claim 1 for the person.

17. The method of claim 16, wherein the person wears the bracelet and the persons goes to at least one station, wherein the at least one station contains one more devices or structures configured to provide the sensory input of the icon.

18. The method of claim 17, wherein the bracelet comprises at least two icons and the person goes to at least two stations that are configured to provide the type of sensory input of each of the at least two icons.

19. The method claim 18 further comprising tracking how much time the person spends at each of the at least two stations.

20. The method according to claim 19, wherein the tracking comprises using a location tracking device and the tracking device is physically associated with the person.
